(19) United States
(12) Patent Application Publication
(10) Pub. No.: US 2014/0368702 A1
(43) Pub. Date: Dec. 18, 2014

(54) PHOTOELECTRIC CONVERSION DEVICE, PHOTOELECTRIC CONVERSION SYSTEM, AND METHOD FOR DRIVING PHOTOELECTRIC CONVERSION DEVICE

(71) Applicant: CANON KABUSHIKI KAISHA, Tokyo (JP)

(72) Inventor: Yukihiro Kuroda, Inagi-shi (JP)

(21) Appl. No.: 14/300,079

(22) Filed: Jun. 9, 2014

(30) Foreign Application Priority Data
Jun. 14, 2013 (JP) 2013-125720

(51) Int. Cl. H04N 5/378; H04N 5/351

(52) U.S. Cl. CPC H04N 5/378; H04N 5/351
USPC 348/273; 348/294; 348/297

(57) ABSTRACT

Sum signals are generated in each region provided with a plurality of photoelectric converters. Furthermore, a second signal line is included to which signals based on the sum signals are output, in addition to a first signal line to which individual signals of a plurality of pixels are output.

### BACKGROUND OF THE INVENTION

1. Field of the Invention

The present invention relates to a photoelectric conversion device, a photoelectric conversion system, and a method for driving the photoelectric conversion device.

2. Description of the Related Art

Japanese Patent Application Laid-Open No. 2005-348041 describes an imaging device including an adding circuit and a non-adding circuit. The adding circuit outputs sum signals resulting from addition of signals output from a plurality of pixels. The non-adding circuit outputs signals output by the plurality of pixels without the addition. In Japanese Patent Application Laid-Open No. 2005-348041, the adding circuit and the non-adding circuit are provided only in one region per a pixel array including the plurality of pixels.

Japanese Patent Application Laid-Open No. 2003-18465 describes an imaging device that operates in an adding mode and a non-adding mode. In the adding mode, sum signals resulting from addition of signals output by a plurality of pixels are generated in a region including a plurality of pixels. The sum signals are output from this region to a signal line. In the non-adding mode, a signal is output from each pixel to the signal line.

### SUMMARY OF THE INVENTION

An aspect of the invention is a photoelectric conversion device, including a light receiving region having a plurality of regions, and first and second signal lines, the regions each including unit cells and a signal output section, the unit cells each including a plurality of photoelectric converters and a cell output section, wherein the cell output section outputs to the first signal line first signals each based on a signal of each of the plurality of photoelectric converters and a second signal based on a sum signal resulting from addition of signals of the plurality of photoelectric converters, the second signal is input from the first signal line to the signal output section, and the signal output section outputs the second signal to the second signal line.

Another aspect of the invention is a photoelectric conversion device, including a light receiving region having a plurality of regions, and first and second signal lines, the regions each including unit cells, an adder section, and a signal output section, the unit cells each including a plurality of photoelectric converters and a cell output section, wherein the cell output section outputs to the first signal line first signals each based on a signal of each of the plurality of photoelectric converters, the first signals are input from the first signal line to each of the adder sections, the adder sections each generate a sum signal resulting from addition of signals of the plurality of photoelectric converters and output the sum signal to each of the signal output sections, and the signal output sections output second signals based on the sum signals to the second signal line.

Still another aspect of the invention is a method for driving a photoelectric conversion device including a plurality of regions provided in a light receiving region and first and second signal lines, the regions each including unit cells, a signal holding section, and a signal output section, the unit cells each including a plurality of photoelectric converters and a cell output section, the method including: outputting to the first signal line by each of the cell output sections of first signals each based on each of signals of the plurality of photoelectric converters and a second signal based on a sum signal resulting from addition of signals of the plurality of photoelectric converters; holding by each of the signal holding sections of the second signals; and outputting to the second signal line by the signal output sections of signals based on the second signals held by the signal holding sections, wherein the signal holding section of one of the regions performs holding the second signal in a period, and the signal holding section of the other one of the regions performs holding the second signal in at least one part period overlapped with the period.

Further features of the present invention will become apparent from the following description of exemplary embodiments (with reference to the attached drawings).

### BRIEF DESCRIPTION OF THE DRAWINGS

FIG. 1A is a diagram of an exemplary configuration of a photoelectric conversion system.

FIG. 1B is a diagram of an exemplary configuration of a photoelectric conversion device.

FIG. 1C is a diagram of an exemplary operation of the photoelectric conversion device.

FIG. 2 is a diagram of an exemplary configuration of the photoelectric conversion device.

FIG. 3 is a diagram of an exemplary configuration of the photoelectric conversion device.

FIG. 4 is a diagram of an exemplary operation of the photoelectric conversion device.

FIG. 5 is a diagram of an exemplary operation of the photoelectric conversion device.

FIG. 6A is a diagram of an exemplary operation of the photoelectric conversion device.

FIG. 6B is a diagram of an exemplary configuration of a readout circuit.

FIG. 7 is a diagram of an exemplary configuration of a photoelectric conversion device.

FIG. 8 is a diagram of an exemplary configuration of a photoelectric conversion device.

FIG. 9 is a diagram of an exemplary configuration of the photoelectric conversion device.

FIG. 10 is a diagram of an exemplary configuration of a photoelectric conversion system.

### DESCRIPTION OF THE EMBODIMENTS

The imaging device in Japanese Patent Application Laid-Open No. 2005-348041 has difficulty in generating the sum signals fast because of the one region including the adding circuit.

In the imaging device in Japanese Patent Application Laid-Open No. 2003-18465, the signal line that receives the sum signals from the region including the plurality of pixels is identical with the signal line that receives the non-sum signals from the region. In the adding mode, the sum signals are output from part of the plurality of pixels to the signal line. Nodes of output switches of the pixels that do not output the sum signals are connected electrically to the signal line. Thus, parasitic components of the output switches of the pixels that do not output the sum signals increase the drive load of the signal line in the non-adding mode. The increased drive load results in a prolonged period from when the pixels start outputting the sum signals to the signal line until the potential of the signal line changes to the potential of the sum signal. Thus, the imaging device in Japanese Patent Application Laid-Open No. 2003-18465 is problematic in that it cannot read the sum signals fast.

Techniques to be described herein have been achieved in light of the problems described above.

Some embodiments will now be described with reference to the drawings.

### First Embodiment

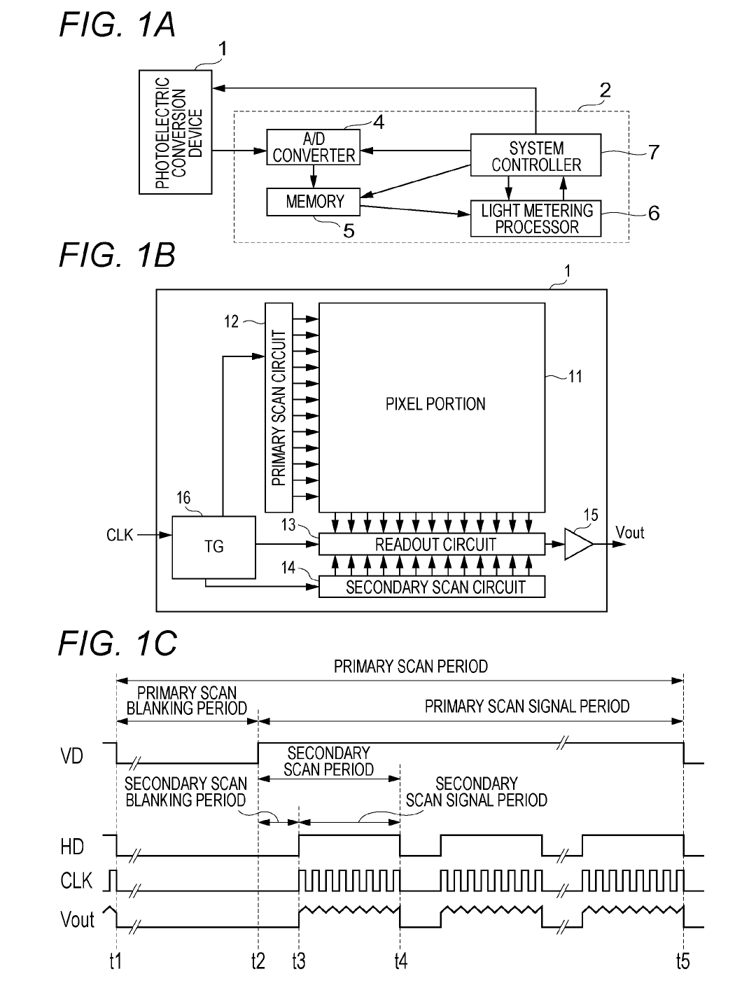

FIG. 1A is a schematic diagram of an exemplary configuration of a photoelectric conversion system according to a first embodiment. The photoelectric conversion system illustrated in FIG. 1A includes a photoelectric conversion device 1 and a calculation section 2. The calculation section 2 includes an analog-to-digital converter (hereinafter referred to as A/D converter) 4, a memory 5, a light metering processor 6, and a system controller 7.

The photoelectric conversion device 1 outputs a signal based on light from a subject to the calculation section 2. The signal output by the photoelectric conversion device 1 to the calculation section 2 is subjected to analog-to-digital conversion by the A/D converter 4. The memory 5 holds a digital signal resulting from the conversion by the A/D converter 4. Operations of the photoelectric conversion device 1 and the A/D converter 4 are controlled by the system controller 7. The memory 5 also outputs the held signal to the light metering processor 6. The light metering processor 6 meters the subject in a way that is based on the output signal. The system controller 7 controls the constituents of the calculation section 2 and the photoelectric conversion device 1.

FIG. 1B is a diagram of an exemplary configuration of the photoelectric conversion device 1. The photoelectric conversion device 1 includes a pixel portion 11, a primary scan circuit 12, a readout circuit 13, a secondary scan circuit 14, an output amplifier 15, and a timing generator (herein after referred to as TG) 16. The pixel portion 11 is a light receiving region that the light from the subject strikes.

The pixel portion 11 includes a plurality of pixels arranged in a matrix. The pixels are provided with photoelectric converters. The primary scan circuit 12 controls reading of an electric charge accumulated in each photoelectric converter, adding of signal electric charges accumulated in the photoelectric converters, and resetting of the photoelectric converters on a basis of per row of the pixel portion 11. Under the control of the primary scan circuit 12, the pixel portion 11 outputs reset level signals and photoelectric conversion signals based on the light from the subject. The readout circuit 13 performs CDS (Correlated Double Sampling) processing on the signals of the pixel portion 11 read by the primary scan circuit 12. Specifically, the readout circuit 13 outputs a signal of difference between a reset level signal and a photoelectric conversion signal. The reset level signal includes offsets inherent to an electrical path from the pixel portion 11 to the readout circuit 13. Through the CDS processing, the readout circuit 13 outputs the photoelectric conversion signals with reduced noise to the output amplifier 15. The secondary scan circuit 14 allows photoelectric conversion signals, which have been subjected to the CDS processing and held in the readout circuit 13, to be output from the readout circuit 13 to the output amplifier 15 sequentially. The output amplifier 15 amplifies a photoelectric conversion signal, which has been subjected to the CDS processing and output by the secondary scan circuit 14 from the readout circuit 13, and outputs the signal as an output signal Vout to the calculation section 2. The output signal Vout is the signal based on the light from the subject and output by the photoelectric conversion device 1 to the calculation section 2. The TG 16 is given an external clock signal CLK. The TG 16 controls operations of the primary scan circuit 12, the readout circuit 13, and the secondary scan circuit 14.

FIG. 1C is a timing chart for describing relationship between the output signal Vout, a vertical synchronizing signal VD, and a horizontal synchronizing signal HD. With the vertical synchronizing signal VD, which is output by the TG 16 to the primary scan circuit 12, at a high level (hereinafter referred to as H level), the primary scan circuit 12 allows the pixel portion 11 to output the reset level signals and the signals based on the light sequentially to the readout circuit 13. A period in which the vertical synchronizing signal VD is at a low level (hereinafter referred to as L level), in other words, the period from a time t1 to a time t2, is a primary scan blanking period. A period in which the vertical synchronizing signal VD is at the H level, in other words, the period from the time t2 to a time t5, is a primary scan signal period. A period resulting from adding one primary scan blanking period and one primary scan signal period, in other words, the period from the time t1 to the time t5, is a primary scan period. In a period in which the horizontal synchronizing signal HD that is input to the TG 16 is at the H level, the TG 16 allows the secondary scan circuit 14 to scan the readout circuit 13. Through this scanning, the readout circuit 13 outputs the photoelectric conversion signals subjected to the CDS processing to the output amplifier 15. The period in which the horizontal synchronizing signal HD is at the H level, in other words, the period from a time t3 to a time t4, is a secondary scan signal period. A period from when the vertical synchronizing signal VD achieves the H level until when the horizontal synchronizing signal HD achieves the H level, in other words, the period from the time t2 to the time t3, is a secondary scan blanking period. A period resulting from adding one secondary scan blanking period and one secondary scan signal period, in other words, the period from the time t2 to the time t4, is a secondary scan period.

The signal Vout illustrated in FIG. 1C is the output signal Vout from the output amplifier 15 illustrated in FIG. 1B.

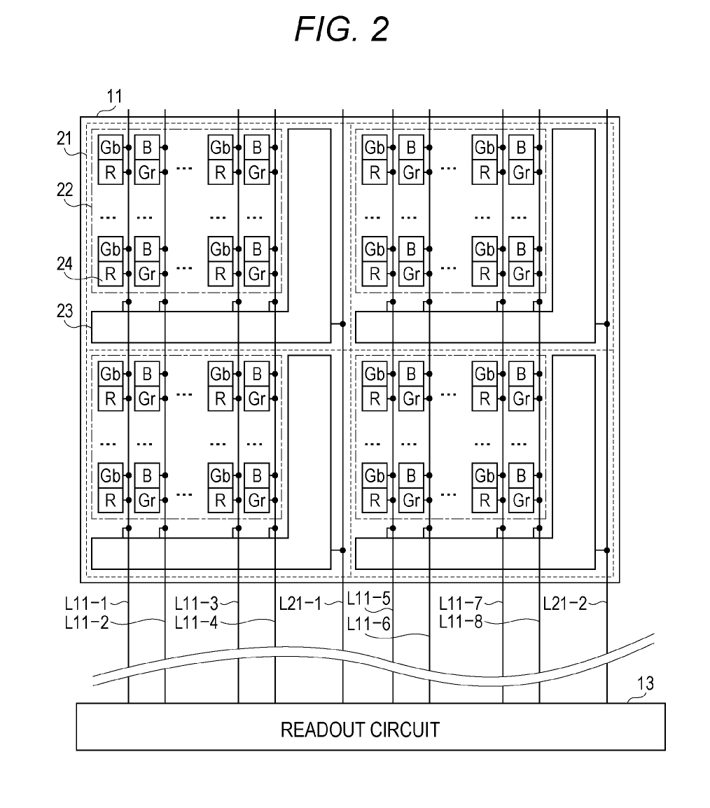

FIG. 2 is a diagram of the pixel portion 11 according to this embodiment.

The pixel portion 11 includes a plurality of regions 21. The pixel portion 11 illustrated in FIG. 2 includes two rows and two columns of the regions 21. Each region 21 is provided with a cell section 22 and a unit signal processor 23.

A photodiode of each pixel 24 in the pixel portion 11 illustrated in FIG. 2 is provided with a color filter. The color of a color filter for a photodiode of each pixel 24 is indicated as “R,” “Gr,” “Gb,” or “B” in each pixel 24 in FIG. 2. For any pixel 24 indicated with “R,” the color of a color filter provided in association with the pixel is red. The pixels 24 indicated with “Gr” are provided in identical rows with the “R” pixels 24, and the color of color filters provided in association with the “Gr” pixels 24 is green. The pixels 24 indicated with “Gb” are provided in identical rows with the “B” pixels 24 and the color of color filters provided in association with the “Gb” pixels 24 is green. First signal lines L11-1 to L11-8 are signal lines to which a signal from each pixel 24 is output. A signal based on addition of signal electric charges generated at some pixels 24 is input into each unit signal processor 23. The unit signal processors 23 in each column output signals based on the input signals to a second signal line L21-1 or L21-2. The unit signal processors 23 arranged in an identical column output the signals to a common one of the second signal lines L21.

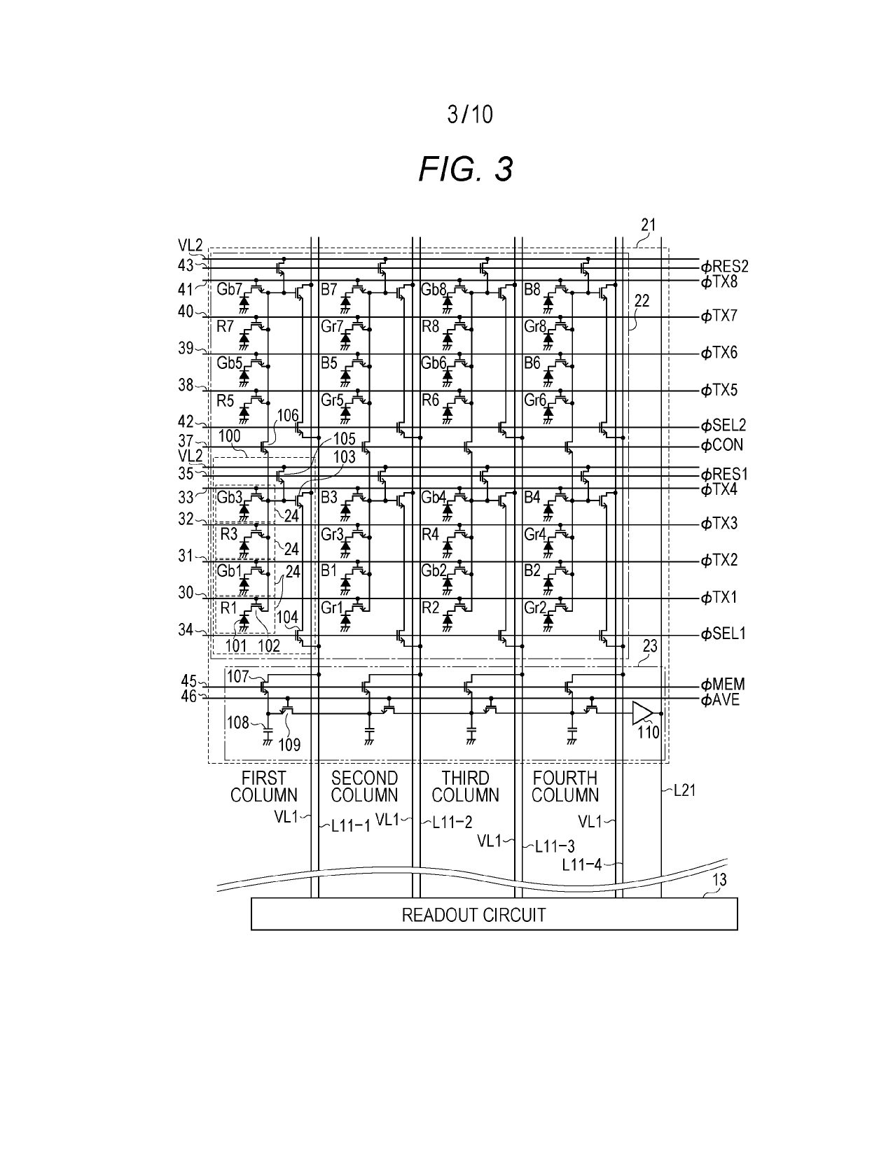

FIG. 3 is a diagram of one of the regions 21 in more detail. Signals supplied to control lines 30 to 35 are signals φTX1, φTX2, φTX3, φTX4, φSEL1, and φRES1, respectively. Signals supplied to control lines 37 to 43 are signals φCON, φTX5, φTX6, φTX7, φTX8, φSEL2, and φRES2, respectively.

The cell section 22 includes a plurality of pixels 24. The pixels 24 each include a photodiode 101 and a transistor 102 that transfers an electric charge accumulated in the photodiode 101. With reference to FIG. 3, a unit cell 100 including pixels 24 indicated with R1, Gb1, R3, and Gb3 will be described. The unit cell 100 includes the four pixels 24, and transistors 103, 104, and 105.

A gate of the transistor 102 is connected to the control line 30, which is connected to the primary scan circuit 12 in FIG. 1. A main node of the transistor 103 receives voltage from a power supply line VL1. Another main node of the transistor 103 is connected electrically to a main node of the transistor 104. Another main node of the transistor 104 is connected electrically to the first signal line L11-1. When the TG 16 allows the signal φSEL1, which is supplied to the control line 34, to achieve the H level, an electrical path from the transistor 103 via the transistor 104 to the first signal line L11-1 is brought into conduction. With a current source, not shown, supplying current to the first signal line L11-1, the transistor 103 operates as a source follower. Thus, the transistor 103 outputs a signal in proportion to a potential of an input node of the transistor 103 via the transistor 104 to the first signal line L11-1. The transistor 103 is a cell output section that outputs a signal of the unit cell 100 to the first signal line.

A main node of the transistor 105 receives voltage from a power supply line VL2. Another main node of the transistor 105 is connected electrically to the input node of the transistor 103.

Each transistor 102 of the pixels 24 indicated with R1, Gb1, R3, and Gb3 in FIG. 3 is connected electrically to the input node of the identical transistor 103.

In FIG. 3, a plurality of unit cells 100 is arranged in a matrix. The transistors associated with one unit cell 100 are marked with reference figures in FIG. 3. Other unit cells 100 each have a similar circuit structure to the unit cell 100 that is marked with the reference figures for the transistors, except for the arrangement of the color filters. The following description will be provided with focus on the unit cell 100 that is marked with the reference figures for the transistors in FIG. 3.

The transistors 102 in an identical row are connected electrically via a common one of the control lines 30, 31, 32, and 33. The transistors 104 in an identical row are connected electrically via the common control line 34. The transistors 105 in an identical row are connected electrically via the common control line 35.

The input nodes of transistors 103 in an identical column are connected electrically via a transistor 106.

The unit signal processor 23 is provided with columns of a capacitive element 108, and transistors 107 and 109. Each column of the capacitive element 108 and the transistors 107 and 109 is provided in association with a column of the unit cells. The unit signal processor 23 also includes an output amplifier 110.

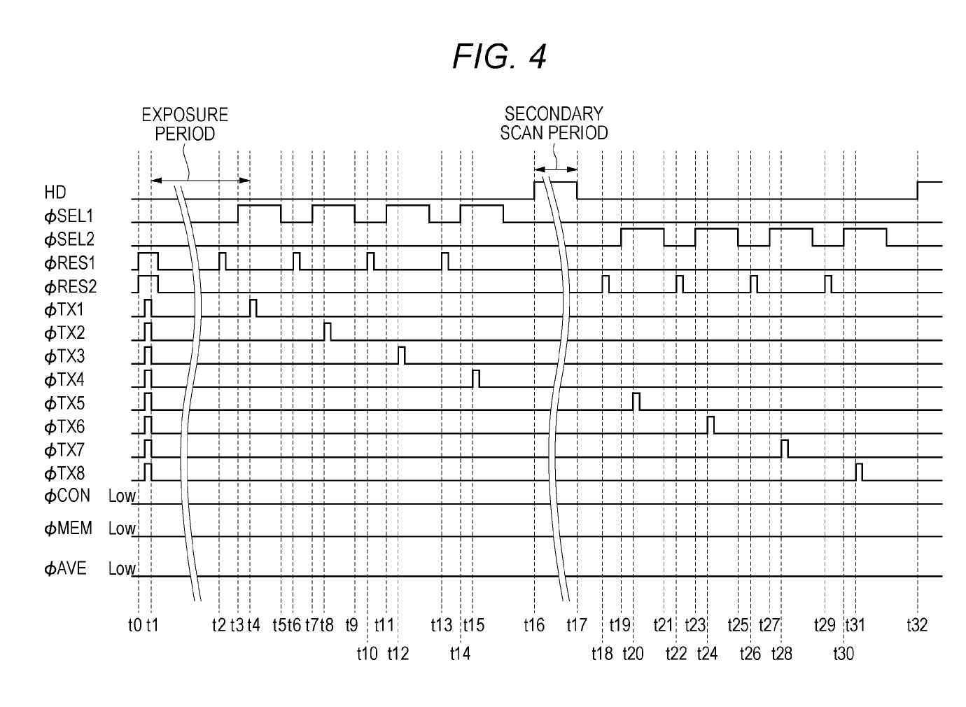

With reference to FIG. 4, operations of the cell section 22 and the unit signal processor 23 illustrated in FIG. 3 will now be described.

FIG. 4 is a timing chart for the operation of the cell section 22 in FIG. 3. In the operation illustrated in FIG. 4, the photodiodes 101 are exposed to the light. Then, in one secondary scan period, the four pixels 24 included in each unit cell 100 output individually signals based on the light via the first signal lines L11 to the readout circuit 13 illustrated in FIG. 1B. Signals illustrated in FIG. 4 correspond to the signals illustrated in FIG. 3. In a period from a time t0 through a time t32 illustrated in FIG. 4, the TG 16 allows the signals φMEM supplied to the control line 45, φAVE supplied to the control line 46, and φCON supplied to the control line 37 all at the L level. In other words, in the operation illustrated in FIG. 4, all the signals output to the first signal lines L11 are not output to the capacitive elements 108 of the unit signal processor 23, but are output to the readout circuit 13.

At the time t0, the TG 16 allows the signals φRES1 and φRES2 to achieve the H level. Then, the TG 16 allows the signals φTX1 to φTX8 to achieve the H level. This resets the potentials of the input nodes of the transistors 103 and the photodiodes 101 of all the pixels 24 included in two rows and four columns of the unit cells 100 illustrated in FIG. 3.

At a time t1, the TG 16 allows the signals φTX1 to φTX8 to achieve the L level. This resets the signal electric charge of the photodiode 101 of each pixel. An exposure period for each pixel 24 in the unit cells 100 is a period from the time t1 until one of the signals φTX input into each pixel 24 is allowed to achieve the H level. In FIG. 4, an exposure period is illustrated for the pixels including the transistors 102 controlled through the signal φTX1.

At a time t2, the TG 16 allows the signal φRES1 to achieve the H level to turn on the transistors 105 connected electrically with the control line 35. This resets the potentials of the input nodes of the transistors 103 connected electrically to the transistors 105 controlled through the control line 35.

At a time t3, the TG 16 allows the signal φSEL1 to achieve the H level. This enables the transistors 104 controlled through the control line 34 to output reset level signals to the first signal lines L11.

At a time t4, the TG 16 allows the signal φTX1 to achieve the H level. This enables signal electric charges accumulated by the photodiodes 101 of the pixels 24 indicated with R1, Gr1, R2, and Gr2 in FIG. 3 to be transferred to the input nodes of the transistors 103 of the respective unit cells 100. This enables the transistors 104 controlled through the control line 34 to output photoelectric conversion signals to the first signal lines L11.

At a time t5, the TG 16 allows the signal φSEL1 to achieve the L level.

At a time t6, the TG 16 allows the signal φRES1 to achieve the H level. This resets the potentials of the input nodes of the transistors 103 connected electrically to the transistors 105 controlled through the control line 35.

At a time t7, the TG 16 allows the signal φSEL1 to achieve the H level. This enables the transistors 104 controlled through the control line 34 to output reset level signals via the first signal lines L11 to the readout circuit 13.

At a time t8, the TG 16 allows the signal φTX2 to achieve the H level. This enables signal electric charges accumulated by the photodiodes 101 of the pixels 24 indicated with Gb1, B1, Gb2, and B2 in FIG. 3 to be transferred to the input nodes of the transistors 103 of the respective unit cells 100. This enables the transistors 104 controlled through the control line 34 to output photoelectric conversion signals to the first signal lines L11.

At a time t9, the TG 16 allows the signal φSEL1 to achieve the L level.

The TG 16 then allows signals φTX3 and φTX4 to achieve the H level sequentially in a manner similar to the operation performed from the time t6 to the time t9. This enables photoelectric conversion signals based on signal electric charges of the respective pixels 24 in the unit cells 100 including the transistors 104 controlled through the signal φSEL1 to be output to the readout circuit 13.

Then, at a time t16, the horizontal synchronizing signal HD is allowed to achieve the H level. In this way, the TG 16 allows the secondary scan circuit 14 to scan a plurality of the readout circuits 13. Thus, each of the readout circuit 13 outputs photoelectric conversion signals subjected to the CDS processing to the output amplifier 15 sequentially. The photoelectric conversion signals subjected to the CDS processing refers to signals of difference between the reset level signals and the photoelectric conversion signals.

Then, in a period from a time t18 through the time t32, the TG 16 performs an operation similar to that performed between the time t1 to the time t16 by controlling the signal φSEL2 instead of the signal φSEL1.

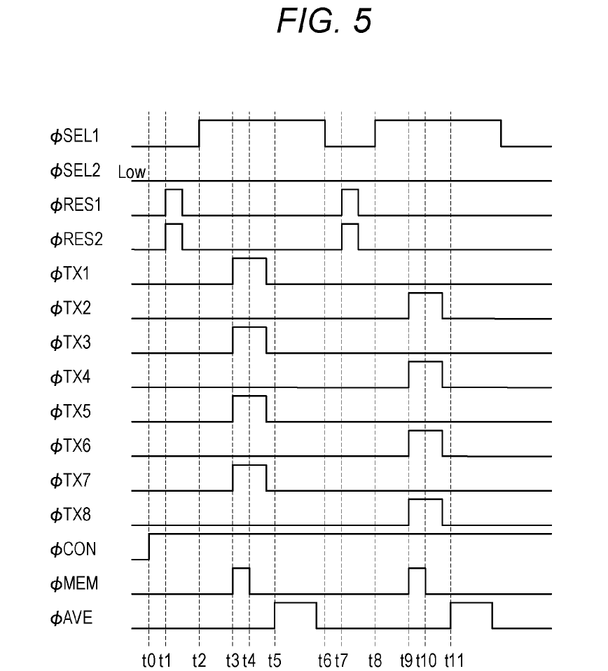

With reference to FIG. 5, an operation will now be described in which the unit cells 100 in the cell section 22 output photoelectric conversion signals to the unit signal processor 23.

At a time t0, the TG 16 allows the signal φCON to achieve the H level. This turns on the transistors 106 illustrated in FIG. 3, bringing an electrical path between the input nodes of the transistors 103 provided in the unit cells 100 in each identical column into conduction.

At a time t1, the TG 16 allows the signals φRES1 and φRES2 to achieve the H level. This resets the potentials of the input nodes of the transistors 103 connected electrically to transistors 105 controlled through the control lines 35 and 43.

At a time t2, the TG 16 allows the signal φSEL1 to achieve the H level. This enables the transistors 104 controlled through the control line 34 to output reset level signals to the first signal lines L11.

At a time t3, the TG 16 allows the signals φTX1, φTX3, φTX5, and φTX7 to achieve the H level. This enables the input nodes of the transistors 103 in the unit cells 100 in first and third columns in FIG. 3 to add signal electric charges of the pixels 24 including the photodiodes 101 provided with the “R” color filters. A signal electric charge resulting from the addition by the input node of each transistor 103 is referred to as a sum signal. In this embodiment, an adder section indicated in a claim is the input node of each of the transistors 103. The input nodes of the transistors 103 in the unit cells 100 in second and fourth columns are enabled to add signal electric charges of the pixels 24 including the photodiodes 101 provided with the “G” color filters. The transistors 104 controlled through the control line 34 in the first to fourth columns each output signals based on the sum signals to the first signal lines L11.

At the time t3, the TG 16 also allows the signal φMEM to achieve the H level. This enables the capacitive elements 108 to each hold the signals based on the sum signals output to one of the first signal lines L11 in a column in association with each of the capacitive elements 108. The capacitive elements 108 according to this embodiment are each a signal holding section that holds a signal based on a sum signal. A signal held by each signal holding section is referred to as a held signal.

At a time t4, the TG 16 allows the signal φMEM to achieve the L level.

At a time t5, the TG 16 allows the signal φAVE to achieve the H level. This brings the capacitive elements 108 in the columns illustrated in FIG. 3 into conduction with each other. Thus, the held signals of the capacitive elements 108 in the columns are averaged, and a resulting averaged held signal is input into the output amplifier 110. Such an averaged held signal is referred to as an average sum signal herein. The average sum signal is a signal based on the held signals of each capacitive element 108. The output amplifier 110 generates an amplified average sum signal. The output amplifier 110 then outputs the average sum signal via one of the second signal lines L21 to the readout circuit 13. An average sum signal according to this embodiment is based on a sum signal. Thus, an average sum signal can be also described as a signal based on a sum signal. The output amplifier 110 according to this embodiment is a signal output section that outputs a signal based on a sum signal.

At a time t6, the TG 16 allows the signal φSEL1 to achieve the L level.

At a time t7, the TG 16 allows the signals φRES1 and φRES2 to achieve the H level. This resets the potentials of the input nodes of the transistors 103 in each unit cell 100.

At a time t8, the TG 16 allows the signal φSEL1 to achieve the H level.

At a time t9, the TG 16 allows the signals φTX2, φTX4, φTX6, and φTX8 to achieve the H level. This enables the input nodes of the transistors 103 in the unit cells 100 in the first and third columns in FIG. 3 to add signal electric charges of the pixels 24 including the photodiodes 101 provided with the “G” color filters. The input nodes of the transistors 103 in the unit cells 100 in the second and fourth columns are enabled to add signal electric charges of the pixels 24 including the photodiodes 101 provided with the “R” color filters. The transistors 104 controlled through the control line 34 in the first to fourth columns each output signals based on sum signals to the first signal lines L11.

At the time t9, the TG 16 also allows the signal φMEM to achieve the H level. This enables the capacitive elements 108 to each hold the signals based on the sum signals output to one of the first signal lines L11 in the respective columns.

At a time t10, the TG 16 allows the signal φMEM to achieve the L level.

At a time t11, the TG 16 allows the signal φAVE to achieve the H level. This brings the capacitive elements 108 in the columns illustrated in FIG. 3 into conduction with each other. Thus, the held signals held by the capacitive elements 108 in the columns are averaged to generate an average sum signal. This average sum signal is input into the output amplifier 110. The output amplifier 110 outputs the average sum signal to the readout circuit 13. The readout circuit 13 outputs the average sum signals, which have been input from the output amplifier 110, to the output amplifier 15 through the scanning by the secondary scan circuit 14.

As described above, the readout circuit 13 outputs to the output amplifier 15 the signals resulting from the CDS processing performed on the photoelectric conversion signals based on the signal electric charges of the individual pixels 24. The readout circuit 13 also outputs to the output amplifier 15 the average sum signals output from the unit signal processor 23. In other words, the readout circuit 13 according to the embodiment is a readout section that receives photoelectric conversion signals based on signal electric charges of the individual pixels 24 and signals based on sum signals.

The photoelectric conversion device according to the embodiment is capable of obtaining signals resulting from the CDS processing performed on photoelectric conversion signals based on signal electric charges of the individual pixels 24, and also average sum signals resulting from the averaging of signals based on sum signals of a plurality of columns of the unit cells 100. This allows the photoelectric conversion system according to the embodiment to obtain a high-resolution image and a low-resolution image.

Additionally, with the adder section generating a sum signal, a signal amplitude of a photoelectric conversion signal can be increased to perform light metering for a low-luminance subject. This allows the photoelectric conversion device according to the embodiment to have an improved S/N ratio for photoelectric conversion signals, in comparison with a case in which signal electric charges of the plurality of pixels 24 are not added up. Thus, the photoelectric conversion system including the photoelectric conversion device according to the embodiment is capable of improving the accuracy of the light metering processing, in comparison with a case in which a photoelectric conversion device does not generate a sum signal of the plurality of pixels 24.

Meanwhile, in the case of the light metering for a high-luminance subject, the accuracy of the light metering processing deteriorates when sum signals are saturated. In such a case, the light metering processing can be performed with photoelectric conversion signals that are based on individual signal electric charges of the plurality of pixels 24 and output by the readout circuit 13.

Thus, the photoelectric conversion device according to the embodiment is capable of performing the light metering processing in desirable manners for subjects in a wider luminance range, in comparison with a case in which only photoelectric conversion signals based on individual signal electric charges of the plurality of pixels 24 are output or with a case in which only average sum signals are output.

Additionally, the photoelectric conversion device according to the embodiment is capable of obtaining signals resulting from the CDS processing performed on photoelectric conversion signals based on signal electric charges of the individual pixels 24, and also average sum signals resulting from the averaging of signals based on sum signals of the plurality of columns of unit cells 100. This allows the calculation section 2 to use the signals resulting from the CDS processing performed on the photoelectric conversion signals based on the signal electric charges of the individual pixels 24 to generate an image. The calculation section 2 can use the generated image to detect a capture scene of a subject. Such capture scenes of subjects include a scene with a subject of interest, such as a person's face, a night scene, and a scene including a high-luminance subject, such as the sun. The calculation section 2 then performs the light metering on the subject in a way that is based on the detected capture scene and the average sum signals. Thus, the photoelectric conversion device according to the embodiment is capable of performing desirable light metering in response to a capture scene.

In the photoelectric conversion device according to the embodiment, each unit cell 100 includes the adder section. The photoelectric conversion device according to the embodiment is capable of generating sum signals faster than the imaging device of Japanese Patent Application Laid-Open No. 2005-348041, which is provided with one region including the adding circuit.

The imaging device of Japanese Patent Application Laid-Open No. 2005-348041 includes one region to hold sum signals per the pixel array. In contrast, the photoelectric conversion device according to the embodiment includes the plurality of unit signal processors 23, and the unit signal processors 23 each hold signals based on sum signals. The photoelectric conversion device according to the embodiment allows the unit signal processors 23 to each hold the signals based on the sum signals in a parallel manner. The photoelectric conversion device according to the embodiment also allows the unit signal processors 23 to each output an average sum signal to the readout circuit 13 in a parallel manner. Thus, the photoelectric conversion device according to the embodiment is capable of reading average sum signals from the plurality of regions 21 faster than the imaging device described in Japanese Patent Application Laid-Open No. 2005-348041.

Additionally, the photoelectric conversion device according to the embodiment includes the plurality of unit signal processors 23. Thus, periods in which the capacitive elements 108 in the mutually different unit signal processors 23 hold signals based on sum signals can be overlapped at least partially. Then, the TG 16 allows the signal φAVE, which is output to the plurality of unit signal processors 23, to achieve the H level, so that the plurality of unit signal processors 23 can generate average sum signals in a parallel manner. In this way, a period taken to generate average sum signals for the regions 21 can be reduced in comparison with a case of one unit signal processor 23.

Additionally, the photoelectric conversion device according to the embodiment allows the plurality of unit signal processors 23 to output average sum signals to the second signal lines L21, which are different from the first signal lines L11. The second signal lines L21 are connected electrically to the unit signal processors 23, resulting in smaller parasitic components than those of the first signal lines L11. Thus, the second signal lines L21 have drive loads smaller than those of the first signal lines L11. Because of this, in the case of the photoelectric conversion device according to the embodiment, the unit signal processors 23 are capable of outputting the average sum signals to the readout circuit 13 faster in comparison with a case in which the unit signal processors 23 output the average sum signals through the first signal lines L11.

The imaging device described in Japanese Patent Application Laid-Open No. 2003-18465 needs a capacitive element provided in each pixel in order to obtain average sum signals. Hence, the imaging device described in Japanese Patent Application Laid-Open No. 2003-18465 suffers a reduction in area of a photodiode in each pixel due to the capacitive elements. The photoelectric conversion device according to the embodiment is provided with the capacitive elements 108 separately from the pixels 24. In this way, the area of the photodiode 101 in each pixel 24 is less likely to be reduced in the photoelectric conversion device according to the embodiment in comparison with the configuration of the imaging device described in Japanese Patent Application Laid-Open No. 2003-18465. Thus, the photoelectric conversion device according to the embodiment is capable of improving the sensitivity of the photodiodes 101 to light, in comparison with the configuration of the imaging device described in Japanese Patent Application Laid-Open No. 2003-18465.

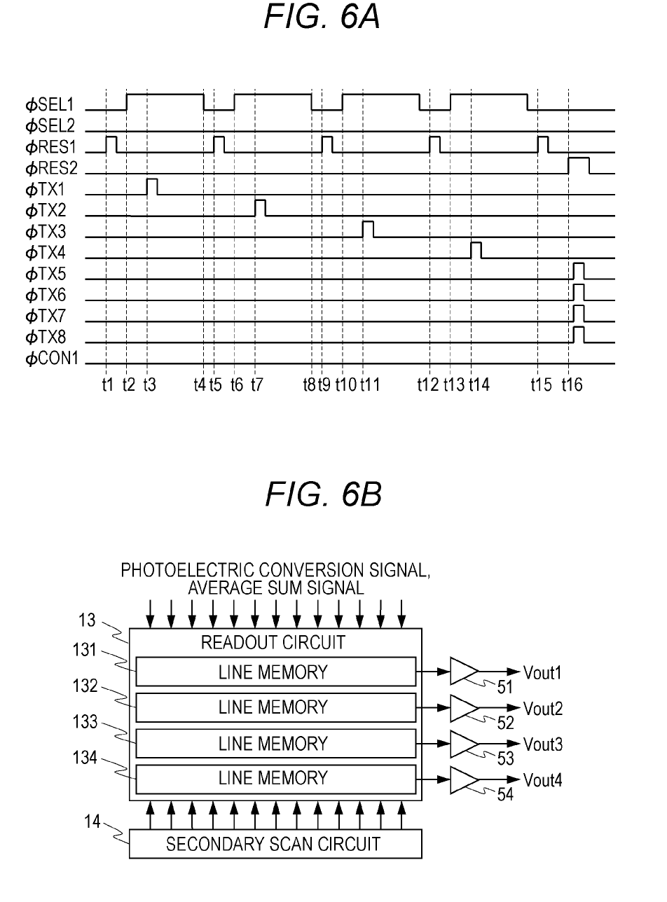

As described above with reference to FIG. 4, the TG 16 allows all the unit cells 100 to perform the identical signal output operation in this embodiment. In another example, the TG 16 may allow the different unit cells 100 to perform different signal output operations. Such an example of signal output operations will now be described with reference to FIG. 6A. Although the signals φMEM and φAVE are not illustrated in FIG. 6A, the TG 16 allows the signals φMEM and φAVE to achieve the L level in a period in which the operations of FIG. 6A are performed.

At a time t1, the TG 16 allows the signal φRES1 to achieve the H level.

At a time t2, the TG 16 allows the signal φSEL1 to achieve the H level. This enables the transistors 104 controlled through the control line 34 to output reset level signals to the first signal lines L11.

At a time t3, the TG 16 allows the signal φTX1 to achieve the H level. This enables the transistors 104 controlled through the control line 34 to output to the first signal lines L11 photoelectric conversion signals based on signal electric charges of the pixels 24 including the transistors 102 controlled through the control line 30.

At a time t4, the signal φSEL1 is allowed to achieve the L level.

The TG 16 then allows photoelectric conversion signals based on signal electric charges of the individual pixels 24 in the unit cells 100 to be output to the first signal lines L11 in a period until a time t15.

At a time t16, the TG 16 allows the signal φRES2 to achieve the H level, and then allows the signals φTX5 to TX8 to achieve the H level. This resets the potentials of the photodiodes 101 of the pixels 24 including the transistors 102 controlled through the control lines 38 to 41.

In other words, the pixels 24 including the transistors 102 controlled through the control lines 30 to 33 perform a rolling shutter operation in the operation illustrated in FIG. 6A. Meanwhile, the pixels 24 including the transistors 102 controlled through the control lines 38 to 41 perform a global shutter operation.

As described above, the TG 16 may allow the different unit cells 100 to perform different signal output operations.

Additionally, the readout circuit 13 according to the embodiment may perform the CDS processing on average sum signals input from the unit signal processors 23. In this case, signals resulting from averaging of reset level signals output by the unit cells 100 can be used as the reset level signals used for the CDS processing.

Additionally, the readout circuit 13 outputs average sum signals to the output amplifier 15 in this embodiment. In another example, the readout circuit 13 may output average sum signals to the outside of the photoelectric conversion device without going through the output amplifier 15.

Furthermore, the photoelectric conversion device includes the one output amplifier 15 in the configuration described with reference to FIG. 1B. In another example, as illustrated in FIG. 6B, the readout circuit 13 may include line memories 131 to 134, and output amplifiers 51 to 54 may be provided for the line memories 131 to 134, respectively. The line memories 131 to 134 each hold signals output by unit cells 100 in a different row. With such a configuration, the output amplifiers 51 to 54 can output in a parallel manner photoelectric conversion signals of the plurality of unit cells 100 and average sum signals of the plurality of regions 21. Thus, the configuration illustrated in FIG. 6B allows photoelectric conversion signals of the plurality of unit cells 100 and average sum signals of the plurality of regions 21 to be output to the outside of the photoelectric conversion device in a period shorter than that for the configuration with the one output amplifier 15.

In the present embodiment, an example has been described in which an average sum signal is input into the output amplifier 110. In another example, a signal resulting from addition of held signals of the plurality of capacitive elements 108 may be input into the output amplifier 110. In such a case, a node that adds up the held signals of the capacitive elements 108 in the plurality of columns is the adder section that adds up signals of the plurality of pixels.

In this embodiment, each unit cell 100 includes a plurality of pixels 24. In another example, each unit cell 100 may include one pixel 24, one transistor 103, and one transistor 104. Additionally, the unit signal processor 23 may be configured to add signals output by the transistors 104 of the plurality of unit cells 100.

### Second Embodiment

A photoelectric conversion device according to a second embodiment will now be described with focus on a difference from the first embodiment.

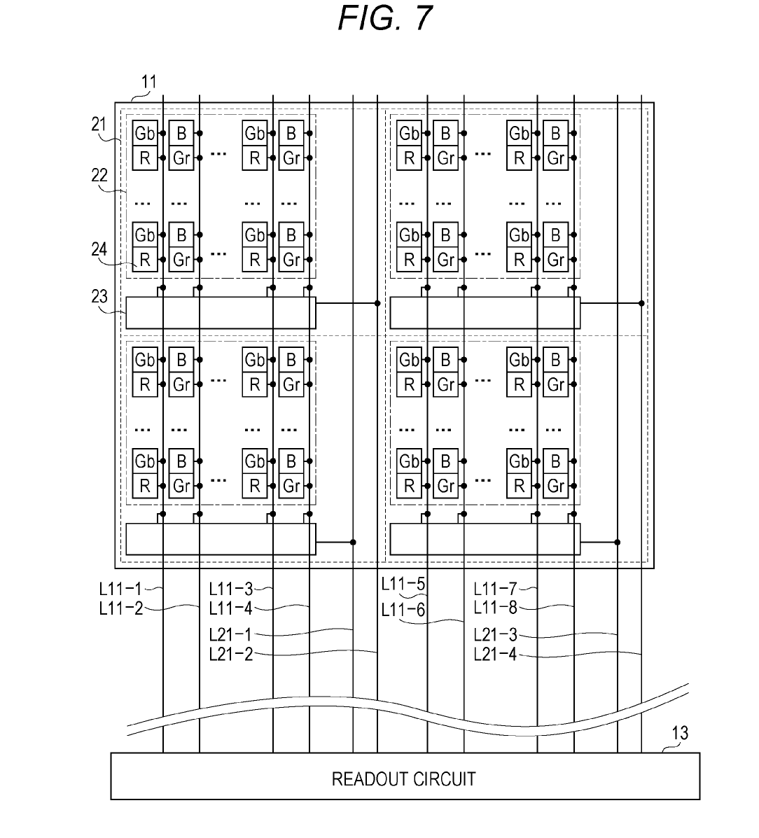

FIG. 7 is a diagram of the photoelectric conversion device according to this embodiment. In FIG. 7, components having similar functions to those illustrated in FIG. 2 are indicated with similar reference figures to those used in FIG. 2.

In the photoelectric conversion device according to the first embodiment, the unit signal processors 23 in the regions 21 in an identical column are connected electrically to a common one of the second signal lines L21. The photoelectric conversion device according to this embodiment is different from the photoelectric conversion device according to the first embodiment in that one of second signal lines L21 is provided in association with each region 21. Because of this, the photoelectric conversion device according to this embodiment allows unit signal processors 23 in the regions 21 in an identical column to output average sum signals simultaneously. Thus, the photoelectric conversion device according to this embodiment is capable of reading average sum signals output by the unit signal processors 23 in the plurality of regions 21 still faster than the photoelectric conversion device according to the first embodiment.

### Third Embodiment

A photoelectric conversion device according to a third embodiment will now be described with focus on a difference from the first embodiment.

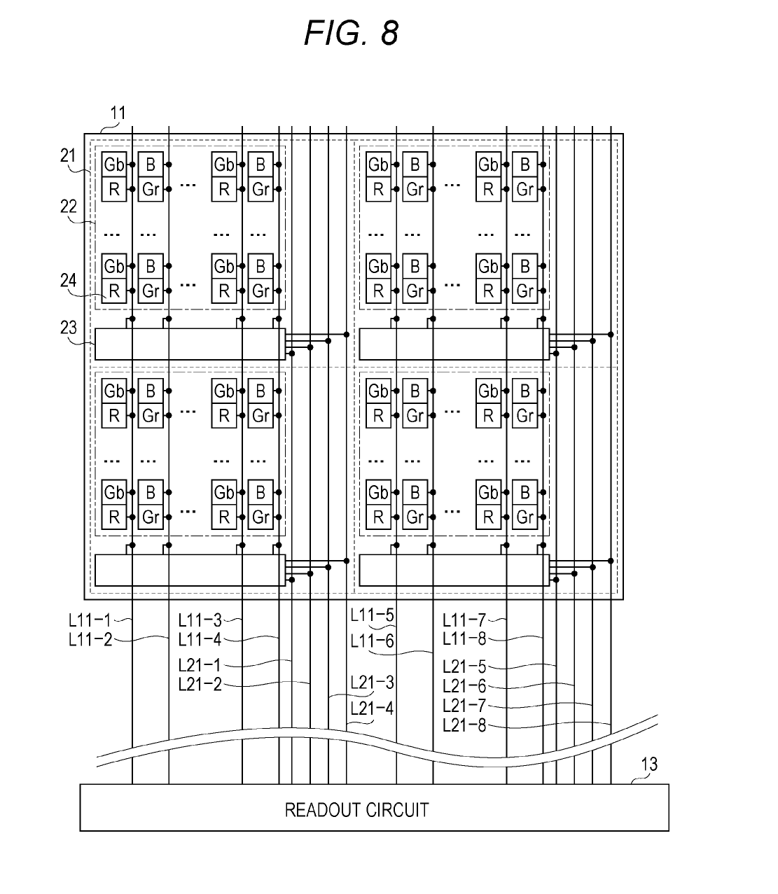

FIG. 8 is a diagram of the photoelectric conversion device according to this embodiment. In FIG. 8, components having similar functions to those illustrated in FIG. 2 are indicated with similar reference figures to those used in FIG. 2.

In the photoelectric conversion device according to this embodiment, a unit signal processor 23 in each region 21 is connected electrically to four second signal lines L21. The four second signal lines L21 are each connected electrically to the unit signal processors 23 in the regions 21.

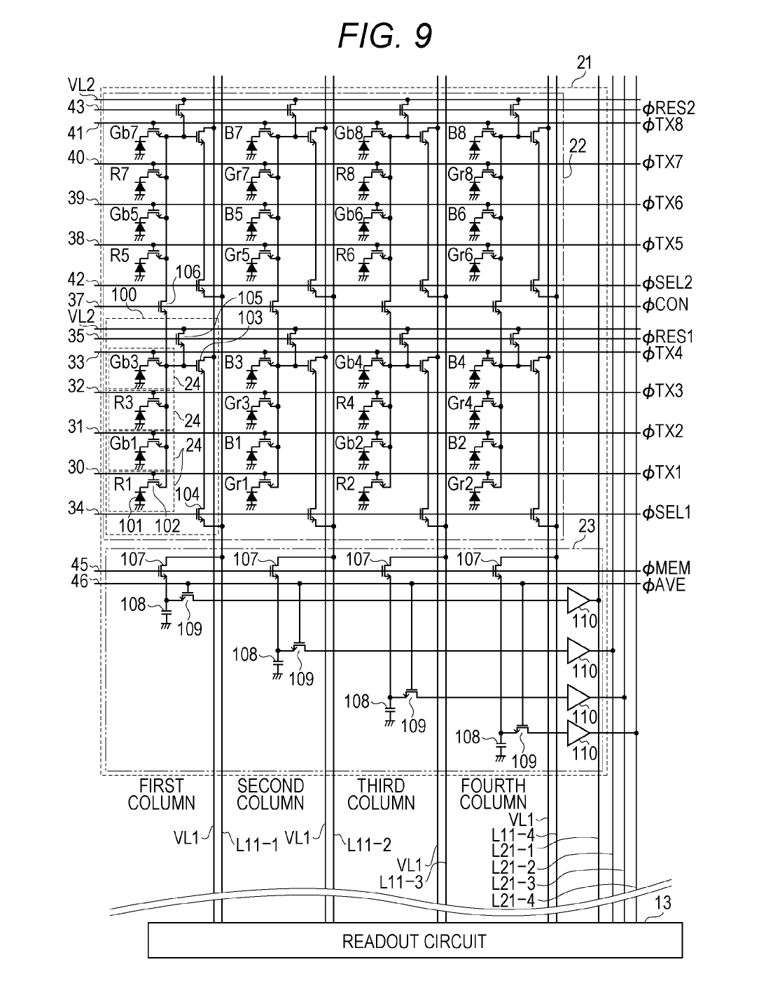

FIG. 9 is a diagram of one of the regions 21 and a readout circuit 13 of the photoelectric conversion device illustrated in FIG. 8. In FIG. 9, components having similar functions to those illustrated in FIG. 3 are indicated with similar reference figures to those used in FIG. 3. An operation of the photoelectric conversion device according to this embodiment may be similar to the operation described with reference to FIG. 5.

As illustrated in FIG. 9, the unit signal processor 23 according to the embodiment includes a plurality of output amplifiers 110. The output amplifiers 110 are each provided in association with a capacitive element 108 in each column. The output amplifiers 110 are each provided in association with one of the second signal lines L21.

With the photoelectric conversion device illustrated in FIG. 9 performing the operation illustrated in FIG. 5 from the time t0 to the time t5, the capacitive element 108 in a first column holds signals based on sum signals of photodiodes 101 of pixels 24 provided with “R” color filters. Similarly, the capacitive elements 108 in second, third, and fourth columns hold signals based on sum signals of pixels 24 provided with color filters of “G,” “R,” and “G”, respectively. Then, a TG 16 allows the signal φAVE to achieve the H level, so that the output amplifiers 110 each output to one of the second signal lines L21 signals based on sum signals of the photodiodes 101 of the pixels 24 provided with the color filters in a same color.

This allows the photoelectric conversion device according to the embodiment to obtain the signals based on the sum signals of the photodiodes 101 of the pixels 24 provided with the color filters in the same colors.

### Fourth Embodiment

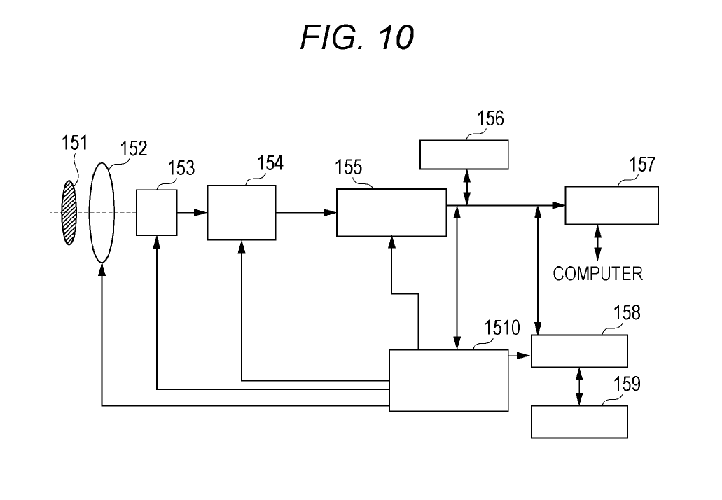

A photoelectric conversion system according to a fourth embodiment will now be described with reference to FIG. 10.

The photoelectric conversion system according to this embodiment uses a signal output by a photoelectric conversion device 154 to generate an image. The photoelectric conversion device 154 may be configured according to any of the first to third embodiments.

The photoelectric conversion system includes a barrier 151, a lens 152, and an aperture 153. The barrier 151 is for protecting the lens. The lens 152 forms an optical image of a subject on the photoelectric conversion device 154 according to the embodiment. The aperture 153 is for varying a quantity of light through the lens 152. The photoelectric conversion system also includes an output signal processor 155 that processes a signal output from the photoelectric conversion device 154. The signal output from the photoelectric conversion device 154 is an imaging signal for generating a capture image that captures the subject. The output signal processor 155 performs various corrections on the imaging signal output from the photoelectric conversion device 154 as appropriate before compressing the signal. The lens 152 and the aperture 153 make up an optical module for concentrating the light onto the photoelectric conversion device 154.

An overall control/calculation section 1510 allows the photoelectric conversion device 154 to perform the operations described in the first to third embodiments. The output signal processor 155 generates an image through the signal output from the photoelectric conversion device 154.

The photoelectric conversion system also includes a buffer memory section 156 for storing temporarily image data and an external interface section 157 for communicating with an external computer and the like. The photoelectric conversion system also includes a removably attachable recording medium 159, such as a semiconductor memory, for recording and reading imaging data and a recording medium control interface section 158 for recording in and reading from the recording medium 159. The photoelectric conversion system also includes the overall control/calculation section 1510 for controlling various calculations and an overall digital still camera.

As described above, the photoelectric conversion system according to the embodiment is capable of generating an image with a signal output by the photoelectric conversion device 154.

Additionally, the output signal processor 155 may use the signal output by the photoelectric conversion device 154 according to the embodiment to perform the light metering processing. In this case, the output signal processor 155 performs the light metering processing to generate light metering data. The output signal processor 155 then outputs the generated light metering data to the overall control/calculation section 1510. The overall control/calculation section 1510 determines an exposure quantity for the photoelectric conversion device 154 based on the input light metering data. The exposure quantity refers to a period in which a shutter of the photoelectric conversion device is open, an aperture quantity of the aperture 153, sensitivity of the photoelectric conversion device 154, and the like.

This allows the photoelectric conversion system to generate an image of a subject captured with an appropriate exposure quantity.

The photoelectric conversion device according to the present invention generates sum signals through addition of signals of the plurality of photoelectric converters in each region provided in the light receiving region and thus is capable of generating the sum signals fast. Furthermore, the photoelectric conversion device according to the present invention includes, in addition to the first signal line to which individual signals of the plurality of photoelectric converters are output, the second signal line to which signals based on the sum signals are output. This allows the photoelectric conversion device according to the present invention to read the signals based on the sum signals fast.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-125720, filed Jun. 14, 2013, which is hereby incorporated by reference herein in its entirety.

What is claimed is:

1. A photoelectric conversion device, comprising a light receiving region having a plurality of regions, and first and second signal lines,
the regions each including unit cells and a signal output section,
the unit cells each including a plurality of photoelectric converters and a cell output section,
wherein the cell output section outputs to the first signal line first signals each based on a signal of each of the plurality of photoelectric converters and a second signal based on a sum signal resulting from addition of signals of the plurality of photoelectric converters,
the second signal is input from the first signal line to the signal output section, and
the signal output section outputs the second signal to the second signal line.

2. The photoelectric conversion device according to claim 1, further comprising a readout section outside the light receiving region,
wherein the first signals are input from each of the regions through the first signal line to the readout section, and
the second signals are input from each of the regions through the second signal line to the readout section.

3. The photoelectric conversion device according to claim 1, wherein the second signal is a signal resulting from averaging of signals each based on each of the sum signals of the unit cells.

4. The photoelectric conversion device according to claim 1, wherein the plurality of regions is arranged in a matrix,
the plurality of photoelectric converters is arranged in a column in each of the unit cells,
the photoelectric conversion device includes a plurality of the first signal lines and a plurality of the second signal lines,
the first signal lines are each provided in association with one of columns of the photoelectric converters, and
the second signal lines are each provided in association with one of columns of the regions.

5. The photoelectric conversion device according to claim 1, wherein each of the signal output sections is provided between the unit cells.

6. The photoelectric conversion device according to claim 1, wherein color filters are provided in association with the photoelectric converters, and
the sum signal is a signal resulting from the addition of signals output by ones of the photoelectric converters, the ones being provided with color filters in a same color.

7. A photoelectric conversion device, comprising a light receiving region having a plurality of regions, and first and second signal lines,
the regions each including unit cells, an adder section, and a signal output section,
the unit cells each including a plurality of photoelectric converters and a cell output section,
wherein the cell output section outputs to the first signal line first signals each based on a signal of each of the plurality of photoelectric converters,
the first signals are input from the first signal line to each of the adder sections,
the adder sections each generate a sum signal resulting from addition of signals of the plurality of photoelectric converters and output the sum signal to each of the signal output sections, and
the signal output sections output second signals based on the sum signals to the second signal line.

8. The photoelectric conversion device according to claim 7, further comprising a readout section outside the light receiving region,
wherein the first signals are input from each of the regions through the first signal line to the readout section, and
the second signals are input from each of the regions through the second signal line to the readout section.

9. The photoelectric conversion device according to claim 7, wherein the second signal is a signal resulting from averaging of signals based on the sum signals of the unit cells.

10. The photoelectric conversion device according to claim 7, wherein the plurality of regions is arranged in a matrix,
the plurality of photoelectric converters is arranged in a column in each of the unit cells,
the photoelectric conversion device includes a plurality of the first signal lines and a plurality of the second signal lines,
the first signal lines are each provided in association with one of columns of the photoelectric converters, and
the second signal lines are each provided in association with one of columns of the regions.

11. The photoelectric conversion device according to claim 7, wherein each of the signal output sections is provided between the unit cells.

12. The photoelectric conversion device according to claim 7, wherein color filters are provided in association with the photoelectric converters, and
the sum signal is a signal resulting from the addition of signals output by ones of the photoelectric converters, the ones being provided with color filters in a same color.

13. A photoelectric conversion system, comprising the photoelectric conversion device according to claim 1 and a light metering processor configured to perform light metering on a subject with a signal output from the photoelectric conversion device.

14. A photoelectric conversion system, comprising the photoelectric conversion device according to claim 7 and a light metering processor configured to perform light metering on a subject with a signal output from the photoelectric conversion device.

15. The photoelectric conversion system according to claim 13, wherein the photoelectric conversion device outputs third and fourth signals to the light metering processor,
the third signals being signals each based on each of the first signals,
the fourth signals being signals each based on each of the second signals,
the light metering processor detects a capture scene of the subject in a way that is based on the fourth signals, and
the light metering processor performs the light metering on the subject in a way that is based on the third signals and the detected capture scene.

16. The photoelectric conversion system according to claim 14, wherein the photoelectric conversion device outputs third and fourth signals to the light metering processor,
the third signals being signals each based on each of the first signals,
the fourth signals being signals each based on each of the second signals,
the light metering processor detects a capture scene of the subject in a way that is based on the fourth signals, and
the light metering processor detects a capture scene of the subject in a way that is based on the fourth signals, and
the light metering processor performs the light metering on the subject in a way that is based on the third signals and the detected capture scene.

17. A photoelectric conversion system, comprising the photoelectric conversion device according to claim 1 and an output signal processor configured to generate an image with a signal output by the photoelectric conversion device.

18. A photoelectric conversion system, comprising the photoelectric conversion device according to claim 7 and an output signal processor configured to generate an image with a signal output by the photoelectric conversion device.

19. A method for driving a photoelectric conversion device,
the photoelectric conversion device including a plurality of regions provided in a light receiving region and first and second signal lines,
the regions each including unit cells, a signal holding section, and a signal output section,
the unit cells each including a plurality of photoelectric converters and a cell output section,
the method comprising:
outputting to the first signal line by each of the cell output sections of first signals each based on each of signals of the plurality of photoelectric converters and a second signal based on a sum signal resulting from addition of signals of the plurality of photoelectric converters;
holding by each of the signal holding sections of the second signals; and
outputting to the second signal line by the signal output sections of signals based on the second signals held by the signal holding sections,
wherein the signal holding section of one of the regions performs holding the second signal in a period, and the signal holding section of the other one of the regions performs holding the second signal in at least one part period overlapped with the period.
